(19) United States
(12) Patent Application Publication
(10) Pub. No.: US 2019/0140907 A1
(43) Pub. Date: May 9, 2019

(54) SYSTEM AND METHOD FOR ACCESS NETWORK EVOLUTION PLANNING

(71) Applicant: First Principles Innovations, LLC, Cary, NC (US)

(72) Inventors: Sudheer Dharanikota, Cary, NC (US); Luc Absillis, Raleigh, NC (US)

(73) Assignee: First Principles Innovations, LLC, Cary, NC (US)

(21) Appl. No.: 16/177,954

(22) Filed: Nov. 1, 2018

Related U.S. Application Data
(60) Provisional application No. 62/580,312, filed on Nov. 1, 2017.

(51) Int. Cl. H04L 12/24

(52) U.S. Cl. CPC H04L 41/12; H04L 41/0889; H04L 41/0813; H04L 41/22

(57) ABSTRACT

A system for outputting a comprehensive and granular access network evolution plan over an extended period of time includes a data store that includes data describing access network states for a specific access network in a corresponding plurality of consecutive time periods, data describing access network resource requirements of the specific access network for each of the corresponding plurality of consecutive time periods, and data describing network topology of the specific access network. A computer processor coupled to the data store is programmed to execute a calculation engine that calculates based on such data a plurality of data describing access network transformation actions for each of consecutive time periods that will fulfill the resource requirements for that period. The processor utilizes the data describing access network transformation actions for each of the plurality of consecutive time periods to calculate a model of a network evolution plan, and utilizes the model of the network evolution plan to provide graphical user interface output or access through an application programming interface by an external tool.

This application is a non-provisional of and claims priority to U.S. Provisional Patent Application No. 62/580,312 filed Nov. 1, 2017, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of access networks, and in particular to a system and method for providing components and methodology to create a comprehensive and granular network-wide evolution plan.

### BACKGROUND

An access network delivers resources to endpoints of the network. For example, a telecommunication access network provides bandwidth (resource) for data communication to private residences or businesses (endpoints). Typically, access networks have a hierarchical structure wherein multiple endpoints are connected with dedicated or shared resources to an access network element; access network elements are logically aggregated together to a second-level of hierarchy; second-level aggregation points are aggregated at a third level, and so on.

Over time the amount of resources that must be delivered to endpoints increases, either through natural growth, the introduction of new services, or external parameters such as competition. This growth requires continuous changes to the access network that need to be carefully planned and budgeted.

### SUMMARY

Described herein is a framework that defines components and methodology to create a comprehensive and granular network-wide evolution plan with detailed cost analysis over a longer period of time. The unique approach allows for a network wide analysis while calculating expansion, detailed evolution, and cost information at a granularity down to individual access network elements. The resulting information from the analysis is detailed enough to be the input for a diverse set of tools, such as financial planning, inventory planning, operational planning, deployment scheduling, etc.

The access network can expand in scope by incorporating access to new endpoints in the so-called greenfield area. Greenfield access network elements can become part of the same evolution framework and planning, and once introduced can be processed by the same transformation methodology.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a diagram illustrating aggregation levels, access network elements, and endpoints.

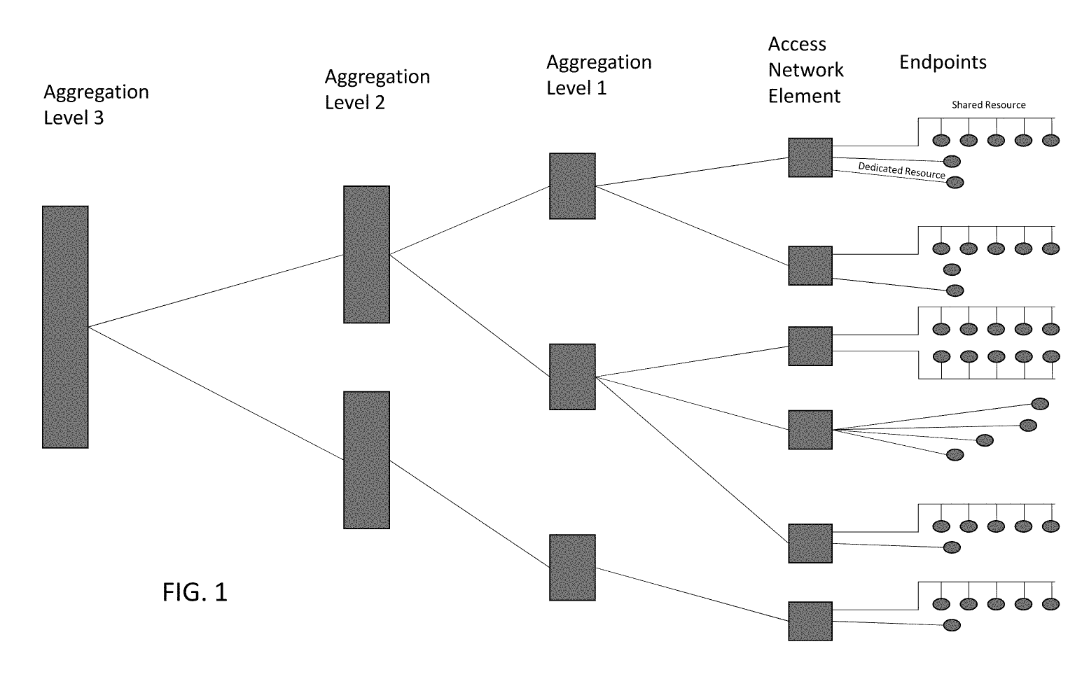

FIG. 2 is a process diagram illustrating network transformation methodology inputs to a core calculation engine.

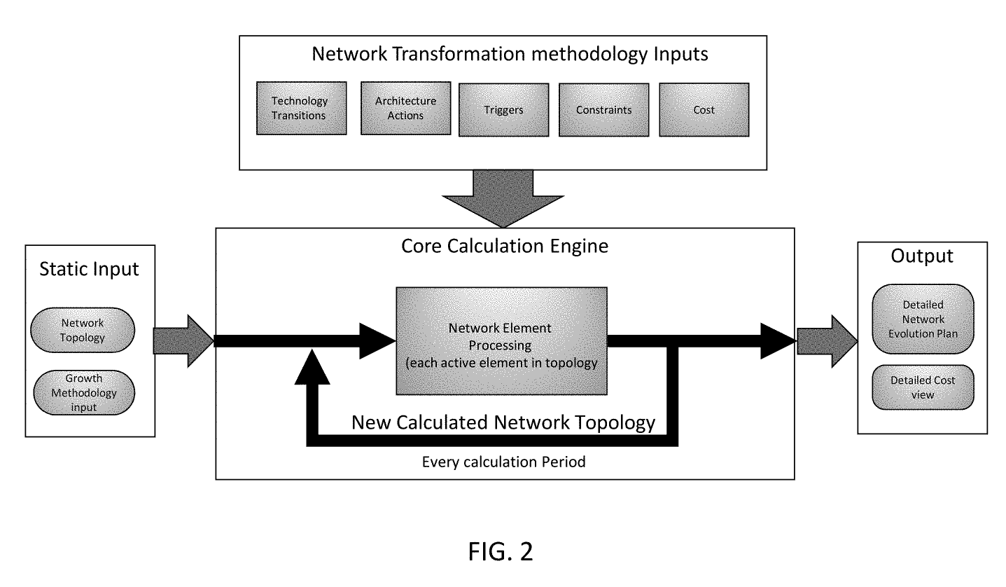

FIG. 3 is a flow diagram illustrating network element processing.

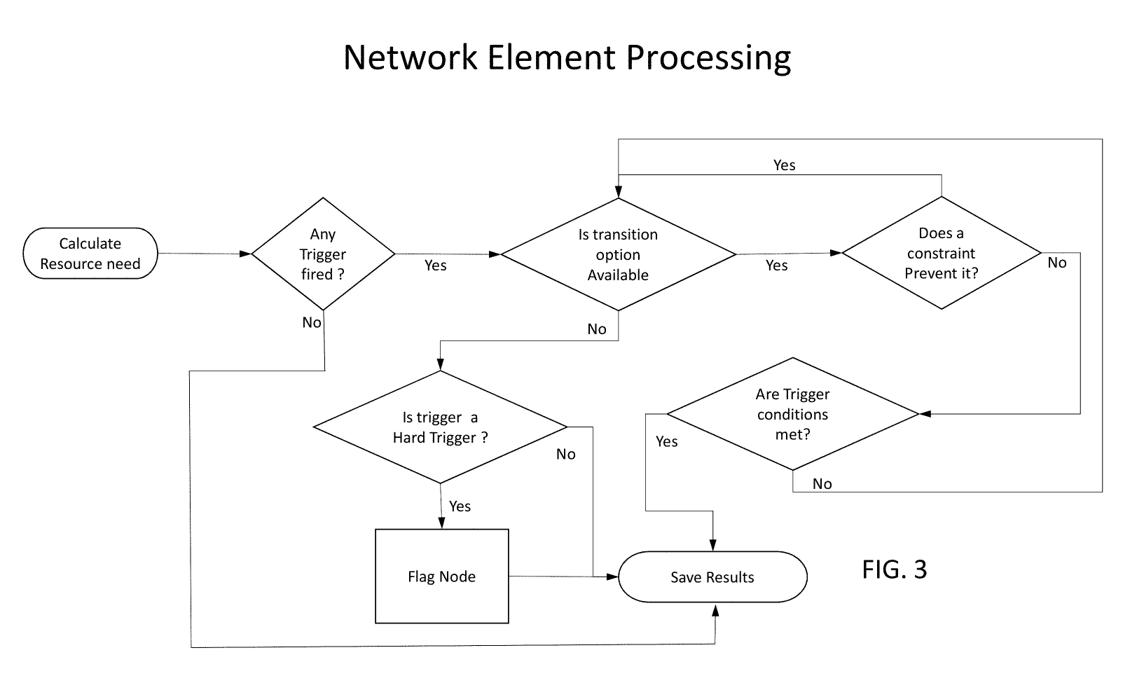

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustration. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a special purpose computer, general purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

### An Embodiment of the Core Function

In an embodiment, the core of the framework is a calculation engine. The calculation starts from the input access network state and for every consecutive period calculates the network transformation actions needed for the access network to deliver on the resource and other requirements for that period. Network transformation actions can be a change in technology, change in access network definition, change in the network architecture (e.g. reducing the amount of end points sharing a resource) or expansion of the access network scope. The framework includes methodologies to model new technology characteristics, new access network characteristics and network actions.

The natural evolution of an access network is driven by growth in resource consumption from endpoints. The basic functionality for the calculation engine is to calculate the new resource requirements by using period-over-period growth level input to determine what network transformation is needed to accommodate the new resource levels. In an embodiment, two methodologies are used to implement this basic functionality:
a. Growth methodology: An innovative growth methodology is introduced in the framework to accommodate and compensate for the fact that growth levels are not uniform in a broader access network. The growth methodology allows for the definition of multiple growth profiles and the assignment of growth profiles down to the level of the access network element enabling full flexibility in defining growth strategies.
b. Network transformation methodology: to define and execute a network transformation action the methodology accepts as input a definition of all network transformation actions that can be performed for a given technology state of a network element. A network transformation action could be upgrading of the network element to a new technology or changing the topology (adding network elements to distribute end points). The calculation engine evaluates the transformation action options in order of priority until one satisfies the new resource or external requirements.

While using the basic functionality based on growth evolution will result in a complete network transformation plan based on actual needs, in reality other factors can contribute to requiring network upgrades. For example, network upgrades could be driven by competition, management decisions to deploy new technologies, operational considerations and others.

To accommodate other triggers for evolution the framework includes a trigger methodology. The trigger methodology allows for different types of triggers steering the calculation engine to a transition action:
a. Forced triggers: Force a technology upgrade or network action at a given period for access network elements within a defined geographical scope selected by node attribute values
b. Conditional triggers: Best effort technology upgrade or network action attempt within a certain time period for access network elements within a defined geographical scope selected by node attribute values
c. Operational trigger: For instance upgrade all network elements in a specific scope (=aggregation hierarchy) to the same technology or perform network action to harmonize architecture within a scope.
d. Service triggers: introduction of a new service.

All triggers can be defined to apply to any scope from the highest aggregation level to the individual access network elements scope. Another attribute of triggers is the concept of forced vs best-effort trigger. If a forced trigger cannot be satisfied, the system can create an error condition that needs to be mediated by modelling network transformation actions.

With the introduction of additional triggers, the framework can effectively model complete network evolution plans. Unfortunately, real life limitations on budgets or available resources, or having to smooth out the usage of resources over time, can make the calculation plan unrealistic. That is why the framework incorporates a constraints methodology that creates a lever allowing the system to model real live limitations. The constraints methodology enables the prevention of network transformation actions when triggers fire. A constraint:
a. Is defined with a certain geographical scope.
b. Is defined by access network element attribute values.
c. Is defined for a range of periods.

### An Embodiment of Usability Functions

For the core functionality to be enabled, the framework includes input and output methodologies. Input methodologies define how to provide the core calculation engine with starting network topology and state, growth profiles and growth profile allocation, technology definitions, network action definitions, transformation options, triggers and constraints. Output methodologies create the detailed network evolution plan for visualization or further post processing.

Both input and output methodologies allow for direct graphical user interface (GUI) input and output to create a planning tool, or to be access through open application programming interfaces to build external tools using the core calculation engine.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

1. A system for outputting a comprehensive and granular access network evolution plan over an extended period of time, comprising:
a) one or more data stores that together include:
i) a plurality of data describing access network states for a specific access network in a corresponding plurality of consecutive time periods;
ii) a plurality of data describing access network resource requirements of the specific access network for each of the corresponding plurality of consecutive time periods; and
iii) data describing network topology of the specific access network;
b) a computer processor coupled to the data store and programmed, upon receiving a command, to execute a calculation engine that:
i) receives input of data specifying at least one period-over-period growth level;
ii) reads the plurality of data describing access network states, the plurality of data describing access network resource requirements, and the data describing network topology of the specific access network from the data store;
iii) calculates based on the plurality of data describing access network states from the data store, the plurality of data describing access network resource requirements and the data specifying at least one period-over-period growth level, a plurality of data describing access network transformation actions for each of the plurality of consecutive time periods that will fulfill the resource requirements for that period;
iv) stores the plurality of data describing access network transformation actions for each of the plurality of consecutive time periods in the data store;
v) reads the plurality of data describing access network transformation actions for each of the plurality of consecutive time periods from the data store;
vi) utilizes the data describing access network transformation actions for each of the plurality of consecutive time periods to calculate a model of a network evolution plan;
vii) utilizes the model of the network evolution plan to provide graphical user interface output or access through an application programming interface by an external tool.

2. The system for outputting a comprehensive and granular access network evolution plan according to claim 1, wherein the data describing access network topology includes data describing greenfield access network elements.

3. The system for outputting a comprehensive and granular access network evolution plan according to claim 1, wherein the data describing access network transformation actions comprises data describing at least one change in technology;

4. The system for outputting a comprehensive and granular access network evolution plan according to claim 1, wherein the data describing access network transformation actions comprises data describing at least one change in access network definition.

5. The system for outputting a comprehensive and granular access network evolution plan according to claim 1, wherein the data describing access network transformation actions comprises data describing at least one change in access network architecture.

6. The system for outputting a comprehensive and granular access network evolution plan according to claim 5, wherein the at least one change in access network architecture comprises at least one change in an amount of end points sharing a resource.

7. The system for outputting a comprehensive and granular access network evolution plan according to claim 1, wherein the data describing access network transformation actions comprises data describing at least one expansion of access network scope.

8. The system for outputting a comprehensive and granular access network evolution plan according to claim 1, wherein the data specifying at least one period-over-period growth level comprises multiple growth profiles and assignment of growth profiles at an access network element level.

9. The system for outputting a comprehensive and granular access network evolution plan according to claim 1, wherein the plurality of data describing access network transformation actions comprises data describing network transformation actions that can be performed for a given technology state of a network element.

10. The system for outputting a comprehensive and granular access network evolution plan according to claim 1, wherein the plurality of data describing access network transformation actions comprises data describing upgrading of the network element to a new technology.

11. The system for outputting a comprehensive and granular access network evolution plan according to claim 1, wherein the plurality of data describing access network transformation actions comprises data describing a change to topology of said specific access network.

12. The system for outputting a comprehensive and granular access network evolution plan according to claim 11, wherein the change to topology of said specific access network comprises an addition of elements to distribute end points.

13. The system for outputting a comprehensive and granular access network evolution plan according to claim 1, wherein the calculation engine executed by the process is configured to evaluate transformation action options in order of priority until one satisfies new resource or external requirements.

14. The system for outputting a comprehensive and granular access network evolution plan according to claim 1, wherein the calculation engine executed by the process is configured to utilize a plurality of triggers to steer toward a transition action.

15. The system for outputting a comprehensive and granular access network evolution plan according to claim 14, wherein the plurality of triggers comprises forced triggers that trigger forcing of at least one technology upgrade or network action at a given period for access network elements within a defined geographical scope selected by access network node attribute values.

16. The system for outputting a comprehensive and granular access network evolution plan according to claim 14, wherein the plurality of triggers comprises conditional triggers that trigger at least one best effort technology upgrade or network action attempt within a certain time period for access network elements within a defined geographical scope selected by node attribute values.

17. The system for outputting a comprehensive and granular access network evolution plan according to claim 14, wherein the plurality of triggers comprises operational triggers.

18. The system for outputting a comprehensive and granular access network evolution plan according to claim 17, wherein the operational triggers trigger upgrade of all network elements in a specific scope to the same technology.

19. The system for outputting a comprehensive and granular access network evolution plan according to claim 17, wherein the operational triggers trigger performing at least one network action to harmonize architecture within a specific scope.

20. The system for outputting a comprehensive and granular access network evolution plan according to claim 14, wherein the plurality of triggers comprises service triggers that trigger introduction of a new service.

21. The system for outputting a comprehensive and granular access network evolution plan according to claim 1, wherein the calculation engine executed by the process is configured to utilize constraints to calculate said model of said network evolution plan, the constraints being defined within a certain geographical scope, by access network element attribute values, and for a range of periods.
